(19) United States
(12) Patent Application Publication
(10) Pub. No.: US 2025/0328331 A1
(43) Pub. Date: Oct. 23, 2025

(54) OPTIMIZED OPERATING SYSTEM IMAGE DEPLOYMENT

(71) Applicant: DELL PRODUCTS L.P., Round Rock, TX (US)

(72) Inventors: Jitendra Kumar, Bangalore (IN); Rajeshkumar Ichchhubhai Patel, Bangalore (IN); Tarun Aitha, Hyderabad (IN)

(73) Assignee: DELL PRODUCTS L.P., Round Rock, TX (US)

(21) Appl. No.: 18/640,070

(22) Filed: Apr. 19, 2024

(51) Int. Cl. G06F 8/61; G06F 9/4401; H04L 67/06

(52) U.S. Cl. CPC G06F 8/63; G06F 9/4406; H04L 67/06

(57) ABSTRACT

Techniques for optimized operating system image deployment are described. One example method includes installing a pseudo-image on a partition of the memory, wherein the pseudo-image is configured to enable the computer system to be booted from the partition, and wherein the pseudo-image is associated with an OS data image stored on a remote server communicatively coupled to the computer system by a network; booting the computer system using the partition of the memory that includes the pseudo-image; executing an OS install program associated with the pseudo-image, including: identifying a request by the OS install program for particular data from the pseudo-image; determining that the requested particular data is not stored in the pseudo-image; and in response to determining that the requested particular data is not stored in the pseudo-image, retrieving the requested particular data over the network from the OS data image on the remote server.

### TECHNICAL FIELD

The present disclosure relates in general to information handling systems, and more particularly to techniques for optimized operating system image deployment in information handling systems.

### BACKGROUND OF THE INVENTION

An image (also referred to as a “disk image”) is a representation of data stored in a particular storage device, such as a hard drive or a flash memory device, and generally includes software programs and associated data for use by a computing device containing the particular storage device. For example, an image of a particular storage device may be created and stored in a different location as a backup copy, and may be used to restore the particular storage device or a different storage to the state represented by the backup copy (e.g., in the event of hardware failure). Images may also be used to quickly initialize one or more computing devices to a standard configuration represented by the image, such as a configuration including a standard set of software programs. In some cases, an image may represent a bit-level representation of the desired state of the storage device, and may include, for example, an initial file system structure, an operating system, software programs, software libraries, drivers, configuration or other data, and the like. In some implementations, an image may be compressed to reduce its data size (e.g., for transfer over a network), and subsequently decompressed by the computing device prior to using the image to initialize a storage device.

Images are often used to initialize devices in a distributed network to a standard configuration. For example, an image of an operating system install package may be written to a device's storage (e.g., a hard drive, random access memory, and the like) and then used to perform a full operating system install on the device. Issues can arise in cases where device storage is limited, as operating system install packages may, in some cases, be several tens or hundreds of gigabytes (GB) in size.

### SUMMARY OF THE INVENTION

In accordance with embodiments of the present disclosure, a method for optimized operating system image deployment includes installing a pseudo-image on a partition of the memory, wherein the pseudo-image is configured to enable the computer system to be booted from the partition, and wherein the pseudo-image is associated with an OS data image stored on a remote server communicatively coupled to the computer system by a network; booting the computer system using the partition of the memory that includes the pseudo-image; executing an OS install program associated with the pseudo-image, including: identifying a request by the OS install program for particular data from the pseudo-image; determining that the requested particular data is not stored in the pseudo-image; and in response to determining that the requested particular data is not stored in the pseudo-image, retrieving the requested particular data over the network from the OS data image on the remote server.

In some cases, the request is a first request, and the method further includes identifying a second request by the OS install program for particular data from the pseudo-image; determining that the particular data requested in the second request is stored in the pseudo-image; and in response to determining that the requested particular data is stored in the pseudo-image, retrieving the requested particular data from the pseudo-image without accessing the remote server.

In some cases, the pseudo-image includes a boot sector, a file allocation table, and a root directory region. In some implementations, the pseudo-image includes a cache, and determining that the requested particular data is not stored in the pseudo-image includes determining that the requested particular data is not stored in the cache of the pseudo-image.

In some cases, the process 300 further includes in response to retrieving the requested particular data over the network from the OS data image on the remote server, storing a copy of the requested particular data in the cache of the pseudo-image.

In some cases, the request is a first request, and the method further includes identifying a second request by the OS install program for the particular data from the pseudo-image; and retrieving the copy of the requested particular data from the cache of the pseudo-image.

In some implementations, the request for the particular data from the pseudo-image includes a file path identifying the particular data. In some cases, determining that the requested particular data is not stored in the pseudo-image includes determining that the cache of the pseudo-image does not include an entry for the file path identifying the particular data.

In accordance with embodiments of the present disclosure, a system for optimized operating system image deployment includes a computer system including at least one processor and a memory, and configured to perform operations including installing a pseudo-image on a partition of the memory, wherein the pseudo-image is configured to enable the computer system to be booted from the partition, and wherein the pseudo-image is associated with an OS data image stored on a remote server communicatively coupled to the computer system by a network; booting the computer system using the partition of the memory that includes the pseudo-image; executing an OS install program associated with the pseudo-image, including: identifying a request by the OS install program for particular data from the pseudo-image; determining that the requested particular data is not stored in the pseudo-image; and in response to determining that the requested particular data is not stored in the pseudo-image, retrieving the requested particular data over the network from the OS data image on the remote server.

In accordance with embodiments of the present disclosure, an article of manufacture includes a non-transitory, computer-readable medium having computer-executable instructions thereon that are executable by a processor of a computer system to perform operations for optimized operating system image deployment including installing a pseudo-image on a partition of the memory, wherein the pseudo-image is configured to enable the computer system to be booted from the partition, and wherein the pseudo-image is associated with an OS data image stored on a remote server communicatively coupled to the computer system by a network; booting the computer system using the partition of the memory that includes the pseudo-image; executing an OS install program associated with the pseudo-image, including: identifying a request by the OS install program for particular data from the pseudo-image; determining that the requested particular data is not stored in the pseudo-image; and in response to determining that the requested particular data is not stored in the pseudo-image, retrieving the requested particular data over the network from the OS data image on the remote server.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE SEVERAL VIEWS OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of example components of a system for optimized operating system image deployment, in accordance with embodiments of the present disclosure;

FIG. 3 illustrates a flow chart of an example process for optimized operating system image deployment, in accordance with embodiments of the present disclosure.

### DETAILED DESCRIPTION OF THE INVENTION

The present disclosure describes techniques for optimized operating system image deployment in information handling systems.

As discussed above, deploying operating systems using images can be problematic when dealing with devices with limited storage, as operating system images can have sizes of several tens or hundreds of GB. In such a case, it may be necessary to convert the operating system image to a different format, such as, for example, a format that implements compression in order to reduce the size of the image. Such conversion wastes computing resources and can lead to costly delays in provisioning large numbers of devices.

Accordingly, the present disclosure describes techniques for optimized operating system image deployment that alleviate the need for this conversion step by allowing the operating system image to be stored on a remote server having sufficient storage space to store the image without conversion. A pseudo-image is stored on the target device which is configured to enable the remote operating system image to be, effectively, mounted over the network and accessed as if it were stored locally to the target device. During the operating system install, the pseudo-image presents a compatible interface and local data format to the device to enable it to access the remote operating system image seamlessly. In addition, the pseudo-image caches recently retrieved portions of the remote operating system image, and fulfills requests for these stored portions from the cache rather than retrieving the portions from the remote server. This functionality may reduce the frequency of network access during the operating system install, leading to improved performance and greater efficiency.

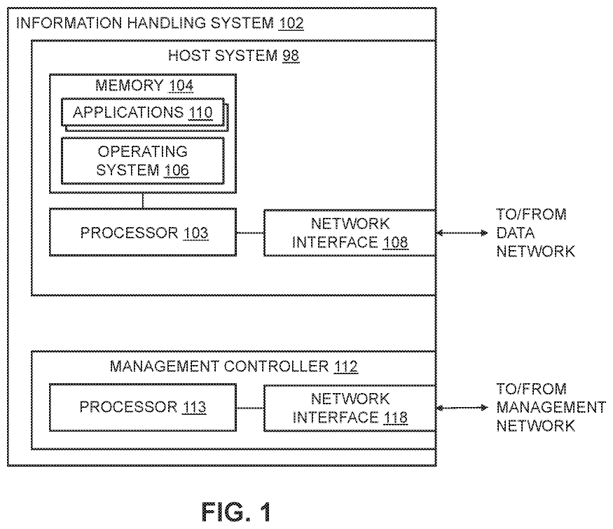

Preferred embodiments and their advantages are best understood by reference to FIGS. 1 through 3, wherein like numbers are used to indicate like and corresponding parts.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103 (e.g., via a management network).

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal integrated circuit processor (DSP), application specific (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

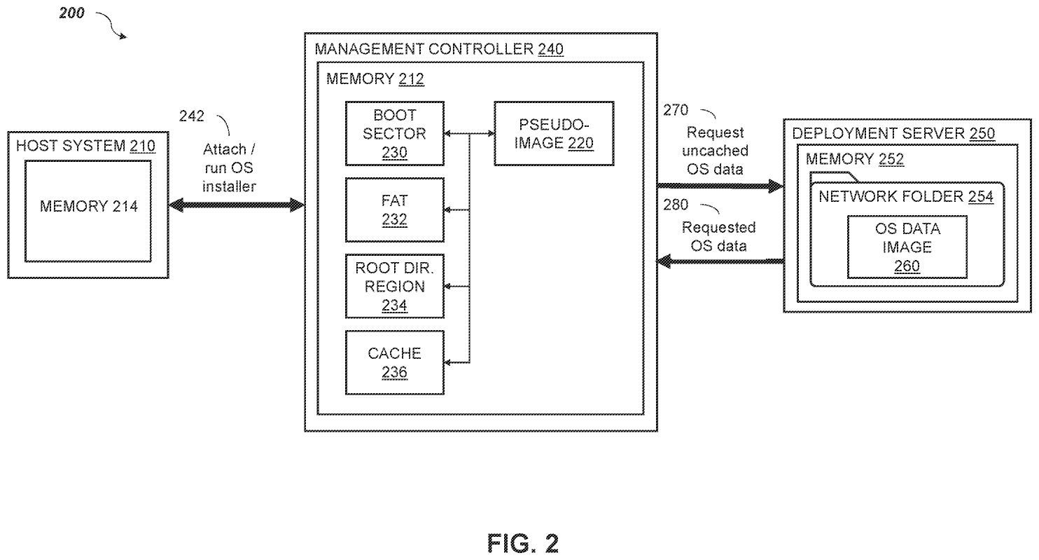

FIG. 2 illustrates a block diagram of example components of a system 200 for optimized operating system image deployment, in accordance with embodiments of the present disclosure.

As shown, the system 200 includes a host system 210 having a memory 214, a management controller 240 having a memory 212 and communicatively coupled to host system 210 by a communications network (not shown), and a deployment server 250 having a memory 252 and being communicatively coupled to management controller 240. The memory 212 of the management controller 240 stores a pseudo-image 220, a boot sector 230, a file allocation table (FAT) 232, a root directory region 234, and a cache 236. The memory 252 of the deployment server 250 includes a network folder 254 storing an operating system (OS) data image 260.

The pseudo-image 220 is an image that provides and manages structures and metadata (e.g., boot sector 230, FAT 232, root directory region 234) that enable it to be used by standard input/output (IO) routines of the host system 210 during an operating system install. These standard IO routines may themselves be part of the pseudo-image, or may be contained in another, previously-initialized storage location (e.g., firmware). The boot sector 230 may contain data used by low-level routines (such as those in the device's firmware or BIOS) to boot up the host system 210, such as, for example, a master boot record, or other such data.

The FAT 232 includes a map indicating the physical storage location of particular data (e.g., files, etc.) managed by the pseudo-image 220. In some cases, the pseudo-image 220 may maintain entries in the FAT 232 corresponding to data or files stored remotely on the deployment server 250 (discussed below). Pseudo-image 220 may be configured to handle requests for these remote resources by retrieving them from the OS data image 260 on the deployment server 250 by requesting the resources from management controller 240 (as described below).

The root directory region 234 provides a local structure corresponding to the highest level of a file system hierarchy. In some cases, the pseudo-image 220 provides and manages the root directory region 234 in order to prevent requests for the root directory of the hierarchy (which are common) from necessitating a network access to the deployment server 250, thereby improving performance.

As described above, the pseudo-image 220 stores a copy of data that has recently been retrieved in cache 236, and provides this copy in response to subsequent requests for the same data rather than retrieving it over the network from the deployment server 250 (as described below). In some cases, the data in the cache 236 is identified by the file path used to request the data. In some implementations, entries in the cache 236 are associated with the “time-to-live” attribute, and are removed from the cache 236 once that amount of time elapses since the last access.

Host system 210 is a computing device communicatively coupled to management controller 240, and may be configured like host system 98 shown and described relative to FIG. 1. In some implementations, the host system 210 may mount a resource within the memory 212 of the management controller 240, and an operating system (OS) installer program may be executed (242). The interaction between the host system 210 and the management controller 240 during the OS install process may be managed by the OS installer program in conjunction with components of the pseudo-image 220.

Deployment server 250 is a computing device communicatively coupled to management controller 240. The deployment server 250 includes memory 252, which in turn includes a network folder 254 that is shared with other computers over the network. In some cases, the network folder 254 may be mounted by other computers (e.g., management controller 240) over the network. Such functionality is well-known in the art, and may be accomplished using any suitable technology (e.g., Network File System (NFS), Common Interface File System (CIFS), etc.).

OS data image 260 is stored in the network folder 254, is thus shared over the network as described above. In some cases, OS data image 260 is an image that contains all data required to perform full operating system install on, for example, host system 210. The OS data image 260 may be formatted according to a common format, such as, for example, ISO/IMG format.

When an operating system install is initiated on host system 210, requests for data will be handled by pseudo-image 220. In operation, when pseudo-image 220 identifies a request for uncached OS data, it requests the data from the deployment server 250 over the network (270). The deployment server 250, in response, retrieves the requested OS data from OS data image 260 and provides it to the management controller 240 (280). Pseudo-image 220 receives the requested data and seamlessly provides the data to the requesting program (e.g., the OS installer). At the conclusion of the OS install process, the operating system represented by the pseudo-image 220 and the OS data image 260 will have been installed in memory 214 of the host system 210.

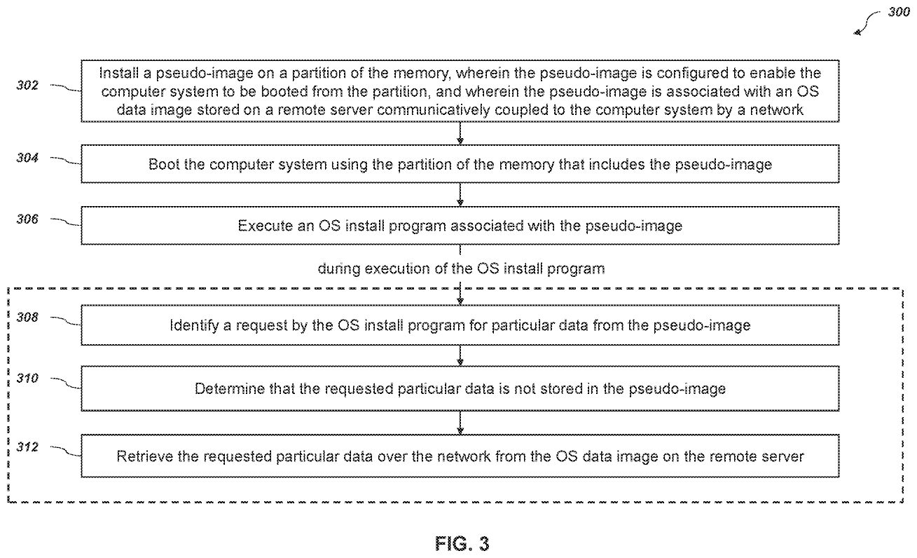

FIG. 3 illustrates a flow chart of an example process 300 for optimized operating system image deployment, in accordance with embodiments of the present disclosure. In some implementations, the process 300 may be performed in the context of the systems of FIGS. 1 and 2.

As shown, at 302, a pseudo-image is installed on a partition of the memory, wherein the pseudo-image is configured to enable the computer system to be booted from the partition, and wherein the pseudo-image is associated with an OS data image stored on a remote server communicatively coupled to the computer system by a network.

At 304, the computer system is booted using the partition of the memory that includes the pseudo-image.

At 306, an OS install program associated with the pseudo-image is executed.

Steps 308, 310, and 312 are performed during execution of the OS install program. At 308, a request by the OS install program for particular data from the pseudo-image is identified. At 310, it is determined that the requested particular data is not stored in the pseudo-image. At 312, in response to determining that the requested particular data is not stored in the pseudo-image, the requested particular data is retrieved over the network from the OS data image on the remote server.

In some cases, the request is a first request, and the process further includes identifying a second request by the OS install program for particular data from the pseudo-image; determining that the particular data requested in the second request is stored in the pseudo-image; and in response to determining that the requested particular data is stored in the pseudo-image, retrieving the requested particular data from the pseudo-image without accessing the remote server.

In some cases, the pseudo-image includes a boot sector, a file allocation table, and a root directory region. In some implementations, the pseudo-image includes a cache, and determining that the requested particular data is not stored in the pseudo-image includes determining that the requested particular data is not stored in the cache of the pseudo-image.

In some cases, the process 300 further includes in response to retrieving the requested particular data over the network from the OS data image on the remote server, storing a copy of the requested particular data in the cache of the pseudo-image.

In some cases, the request is a first request, and the process 300 further includes identifying a second request by the OS install program for the particular data from the pseudo-image; and retrieving the copy of the requested particular data from the cache of the pseudo-image.

In some implementations, the request for the particular data from the pseudo-image includes a file path identifying the particular data. In some cases, determining that the requested particular data is not stored in the pseudo-image includes determining that the cache of the pseudo-image does not include an entry for the file path identifying the particular data.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. A method for optimized operating system (OS) image deployment, the method comprising:
installing, by a computer system, a pseudo-image on a partition of a memory of the computer system, wherein the pseudo-image is configured to enable the computer system to be booted from the partition, and wherein the pseudo-image is associated with an OS data image stored on a remote server communicatively coupled to the computer system by a network;
booting the computer system using the partition of the memory that includes the pseudo-image;
executing, by the computer system, an OS install program associated with the pseudo-image;
during execution of the OS install program:
identifying, by the computer system, a request by the OS install program for particular data from the pseudo-image;
determining, by the computer system, that the requested particular data is not stored in the pseudo-image; and
in response to determining that the requested particular data is not stored in the pseudo-image, retrieving, by the computer system, the requested particular data over the network from the OS data image on the remote server.

2. The method of claim 1, wherein the request is a first request, and the method further comprising:
identifying, by the computer system, a second request by the OS install program for particular data from the pseudo-image;
determining, by the computer system, that the particular data requested in the second request is stored in the pseudo-image; and
in response to determining that the requested particular data is stored in the pseudo-image, retrieving, by the computer system, the requested particular data from the pseudo-image without accessing the remote server.

3. The method of claim 1, wherein the pseudo-image includes a boot sector, a file allocation table, and a root directory region.

4. The method of claim 1, wherein the pseudo-image includes a cache.

5. The method of claim 4, wherein determining that the requested particular data is not stored in the pseudo-image includes determining that the requested particular data is not stored in the cache of the pseudo-image.

6. The method of claim 5, further comprising:
in response to retrieving the requested particular data over the network from the OS data image on the remote server, storing, by the computer system, a copy of the requested particular data in the cache of the pseudo-image.

7. The method of claim 1, wherein the request is a first request, and the method further comprising:
identifying, by the computer system, a second request by the OS install program for the particular data from the pseudo-image;
retrieving, by the computer system, the copy of the requested particular data from the cache of the pseudo-image.

8. The method of claim 1, wherein the request for the particular data from the pseudo-image includes a file path identifying the particular data.

9. The method of claim 8, wherein determining that the requested particular data is not stored in the pseudo-image includes determining that the cache of the pseudo-image does not include an entry for the file path identifying the particular data.

10. A system for optimized operating system (OS) image deployment comprising:
a computer system including at least one processor and a memory, and configured to perform operations including:
installing a pseudo-image on a partition of the memory, wherein the pseudo-image is configured to enable the computer system to be booted from the partition, and wherein the pseudo-image is associated with an OS data image stored on a remote server communicatively coupled to the computer system by a network;
booting the computer system using the partition of the memory that includes the pseudo-image;
executing an OS install program associated with the pseudo-image;
during execution of the OS install program:
identifying a request by the OS install program for particular data from the pseudo-image;
determining that the requested particular data is not stored in the pseudo-image; and
in response to determining that the requested particular data is not stored in the pseudo-image, retrieving the requested particular data over the network from the OS data image on the remote server.

11. The system of claim 10, wherein the request is a first request, and the operations further comprising:
identifying a second request by the OS install program for particular data from the pseudo-image;
determining that the particular data requested in the second request is stored in the pseudo-image; and
in response to determining that the requested particular data is stored in the pseudo-image, retrieving the requested particular data from the pseudo-image without accessing the remote server.

12. The system of claim 10, wherein the pseudo-image includes a boot sector, a file allocation table, and a root directory region.

13. The system of claim 10, wherein the pseudo-image includes a cache.

14. The system of claim 13, wherein determining that the requested particular data is not stored in the pseudo-image includes determining that the requested particular data is not stored in the cache of the pseudo-image.

15. The system of claim 14, the operations further comprising:
in response to retrieving the requested particular data over the network from the OS data image on the remote server, storing a copy of the requested particular data in the cache of the pseudo-image.

16. The system of claim 10, wherein the request is a first request, and the operations further comprising:
identifying a second request by the OS install program for the particular data from the pseudo-image;
retrieving the copy of the requested particular data from the cache of the pseudo-image.

17. The system of claim 10, wherein the request for the particular data from the pseudo-image includes a file path identifying the particular data.

18. The system of claim 17, wherein determining that the requested particular data is not stored in the pseudo-image includes determining that the cache of the pseudo-image does not include an entry for the file path identifying the particular data.

19. An article of manufacture comprising a non-transitory, computer-readable medium having computer-executable instructions thereon that are executable by a processor of a computer system to perform operations for optimized operating system (OS) image deployment, the operations comprising:
installing a pseudo-image on a partition of the memory, wherein the pseudo-image is configured to enable the computer system to be booted from the partition, and wherein the pseudo-image is associated with an OS data image stored on a remote server communicatively coupled to the computer system by a network;
booting the computer system using the partition of the memory that includes the pseudo-image;
executing an OS install program associated with the pseudo-image:
during execution of the OS install program:
identifying a request by the OS install program for particular data from the pseudo-image;
determining that the requested particular data is not stored in the pseudo-image; and
in response to determining that the requested particular data is not stored in the pseudo-image, retrieving the requested particular data over the network from the OS data image on the remote server.

20. The article of claim 19, wherein the request is a first request, and the operations further comprising:
identifying a second request by the OS install program for particular data from the pseudo-image;
determining that the particular data requested in the second request is stored in the pseudo-image; and
in response to determining that the requested particular data is stored in the pseudo-image, retrieving the requested particular data from the pseudo-image without accessing the remote server.
